(19) United States
(12) Patent Application Publication
(10) Pub. No.: US 2009/0319450 A1
(43) Pub. Date: Dec. 24, 2009

(54) PROTEIN SEARCH METHOD AND DEVICE

(76) Inventors: Reiji Teramoto, Tokyo (JP); Hirotaka Minagawa, Tokyo (JP); Kenichi Kamijo, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 12/373,675

(22) PCT Filed: Jul. 9, 2007
(86) PCT No.: PCT/JP2007/063640

§ 371 Date: Jan. 13, 2009

(30) Foreign Application Priority Data
Jul. 14, 2006 (JP) 2006-194065

(51) Int. Cl. G06F 15/18; G06F 19/00; G06N 7/02

(52) U.S. Cl. 706/12; 702/19; 706/52

(57) ABSTRACT

A protein search method for searching for, as a target protein, a protein having direct or indirect relevance to information based on protein representation profiling data acquired by means of proteome analysis includes: determining, as a target protein, a protein that is relevant to the information based on significance of proteins obtained by using supervised learning from the information and the protein representation in the profiling data; and evaluating the performance of the target protein by means of evaluation data.

### TECHNICAL FIELD

The present invention relates to a method and a device for searching for protein that is directly or indirectly relevant to information such as clinical information.

### BACKGROUND ART

In recent years, improvements in the comprehensive analysis technology of proteins, referred to as proteome analysis, that uses mass spectrometry, two-dimensional electrophoresis and the like have led to the active investigation of marker proteins useful in the diagnosis of diseases and the functional analysis of proteins. Proteome analysis typically refers to analysis in which, from a sample that originates from, for example, a biopsy, various types of proteins or the like present in the sample are separated into components and each of the separated components then is identified.

One actual example of methods of proteome analysis involves: first preparing a sample, carrying out two-dimensional electrophoresis to separate the proteins, selecting spots that have been made visible by staining the gel obtained in the two-dimensional electrophoresis, and subjecting the extract obtained by further enzyme processing or the like to mass spectrometry (MS) to predict which proteins are included in the sample. Spots that have been made visible each corresponds to a separated protein. In addition to the above-mentioned method that combines two-dimensional electrophoresis and mass spectrometry, methods of proteome analysis also include processes in which only one of two-dimensional electrophoresis and mass spectrometry is implemented after carrying out an appropriate sample preprocess. There are also methods that employ still other protein identification methods.

One method of two-dimensional electrophoresis that is frequently used in proteome analysis is 2D-DIGE (2-dimensional Fluorescence Difference Gel Electrophoresis). 2D-DIGE is a technique for profiling representation and modification information of protein and is suitable for the quantitative comparison of the proteins in samples. In addition, one mass spectrometry method frequently employed in proteome analysis uses a SELDI (Surface-Enhanced Laser Desorption/Ionization) chip. Mass spectrometry that uses a SELDI chip is a technique suitable for profiling of proteins, and by using this method, the quantitative comparison of proteins among samples is carried out based on mass spectra.

However, it is well known that in some animals including humans significant differences often occur in the representation of a specific protein in samples obtained from individuals that have contracted a disease and samples obtained from individual that are normal.

Precise measurement of protein obtained from an individual is effective in the diagnosis of diseases. In addition, to carry out this type of diagnosis, it is crucial to determine for each disease the protein for which there is a significant difference in representation between an individual that has contracted the disease and a normal individual. Proteins for which significant differences occur in representations between normal individuals and diseased individuals are referred to as “marker proteins.” The search for a marker protein involves both an investigation of the relation between the representation of protein and clinical information such as the morbid state or the treatment record and the implementation of statistical processes to search for protein that exhibits a significant relevance to clinical information.

A method according to John M. Luk et. al [B1] is one example of a method for carrying out a quantitative comparison of proteins between a sample from a diseased individual and sample from a normal individual. In the method of Luk et. al, the protein representation obtained by two-dimensional electrophoresis is compared while using a test statistic used in a t-test or ANOVA (analysis of variance) as an indicator. Luk et. al use this method to focus only on the proteins having the three highest test statistics to evaluate the capability to distinguish cancerous and noncancerous areas in liver cancer and to evaluate the correlation with existing marker proteins or clinical information.

As a neighboring technique of the present invention, JP-A-2003-038377 [A1] discloses a method of designing a functional nucleic acid sequence used in gene manifestation control that uses the RNA (Ribonucleic Acid) interference phenomenon. In this method, an oligonucleotide is extracted from a target gene sequence that is an mRNA (messenger RNA), this sequence is taken as input data of a design candidate sequence, characteristic extraction is carried out by a kernel method based on an already known training sequence and the design candidate sequence, and supervised learning is carried out to predict an effective functional nucleic acid sequence for the target gene. The training sequence is an oligonucleotide sequence that has already been deemed effective in gene manifestation control. Essentially, the method disclosed in JP-A-2003-038377 predicts a functional nucleic acid sequence from a design candidate sequence by comparing with an already known functional nucleic acid sequence, and as a result, cannot be used for the purpose of searching for marker proteins based on information such as clinical information even when nucleic acid sequences are replaced by amino acid sequences.

As a technique relating to the present invention, WO2002/047007 [A2] discloses the use of machine learning to classify and predict genetic diseases.

O. Troyanskaya et. al [B2] disclose a missing value complementing method based on a nearest neighbor algorithm. JP-A-2004-126857 [A3] similarly discloses the use of a k-nearest neighbor algorithm to estimate missing values in the gene manifestation data.

Stochastic gradient boosting, which is one method in machine learning, is a development of gradient boosting. Stochastic gradient boosting is described in [B3], and gradient boosting is described in [B4]. Stochastic gradient boosting and gradient boosting are both a type of ensemble learning, representative modes of ensemble learning being the boosting described in [B5] and the bagging described in [B6]. Decision trees and regression trees are frequently used as subordinate learning machines of ensemble learning, and these are described in [B7].

Reference literatures cited in the present description are listed hereinbelow:
[A1] JP-A-2003-038377.
[A2] WO2002/047007 (JP-A-2004-524604).
[A3] JP-A-2004-126857.
[B1] John M. Luk, et. al; “Proteomic profiling of hepatocellular carcinoma in Chinese cohort reveals heat-shock proteins (Hsp27, Hsp70, GRP78) up-regulation and their associated prognostic values,” Proteomics, 2006, 6, 1049-1057.
[B2] O. Troyanskaya, M. Cantor, G. Sherlock, P. Brown, T. Hastie, R. Tibshirani, D. Botstein, and R. B. Altman; “Missing value estimation methods for DNA microarrays,” Bioinformatics, 2001, 17, 520-525.
[B3]: J. Friedman; “Stochastic gradient boosting,” Computational Statistics and Data Analysis, 2002, 367-378.
[B4]: J. Friedman; “Greedy Function Approximation: A Gradient Boosting Machine,” The Annals of Statistics, 2001, 1189-1232.
[B5]: Y. Freund, R. E. Schapire; “A decision-theoretic generalization of on-line learning and an application to boosting,” Journal of Computer and System Sciences, 1997, 23-27.
[B6]: Leo Breiman; “Bagging Predictors,” Machine Learning, 1996, 123-140.
[B7]: Andreas Buja and Yung-Seop Lee: “Data mining criteria for tree-based regression and classification,” Proceedings of the seventh ACM SIGKDD international conference on knowledge discovery and data mining, pp. 27-36, 2001.

### DISCLOSURE OF THE INVENTION

### Problem to be Solved by the Invention

A method for carrying out a quantitative comparison of proteins between samples from normal individuals and samples from diseased individuals such as method of Luk et al [B1] has problems that should be solved from the standpoint of the search for marker proteins, as described hereinbelow.

First, the correlations between the representation of each protein among groups and clinical information are independently examined to determine the existence of correlations with, for example, clinical information, whereby a dependency on threshold values is seen in the test statistics, but the rationality of the grounds for setting this threshold value is extremely weak. In addition, because independent statistical tests are carried out for each individual protein, this approach is not effective when the representations of a plurality of proteins correlate with clinical information. It is known that, typically, a multiplicity of biomolecules are complexly involved in the mechanism of a morbid state or the efficacy of a drug, and the above-described methods therefore cannot be considered appropriate as methods for searching for marker proteins.

When a two-dimensional electrophoresis method is used, difficulty is encountered in obtaining correlations between samples of spots that correspond to the same protein due to: the unavoidability of a decrease in the reproducibility in experimentation, the infiltration of noise, and further, the limits of image processing technology during processing when electrophoresis images are imported as picture images. There is consequently a potential for a marked reduction of the exhaustivity of proteins that can be compared between groups. In addition, it is not clear which proteins actually correspond to spots that are observed at the stage in which proteins have been spread out by a two-dimensional electrophoresis method or to peaks that are observed at the stage of a mass spectrum that is measured by means of mass spectrometry. As a result, the amino acid sequences that correspond to spots or peaks must be identified to clarify the identity of the proteins, but this operation requires a massive amount of time and effort.

In addition, by means of proteome analysis, data of each representation for a multiplicity of proteins are obtained as protein representation profiling data from one sample, but data loss can occur. The loss of data is the inability to obtain data of the representations regarding several proteins even though these proteins should actually be contained in a sample. This type of loss can occur due to such reasons as insufficient resolution in measurement, limits in the imaging process, or the adherence of extraneous matter or noise in electrophoresis images. Improvement of the exhaustivity in the search for marker proteins requires consideration of this type of data loss, and in some cases, necessitates the complementing of missing values.

In view of the above-described problems, it is an object of the present invention to provide a new analysis method that enables the search for, as target proteins, proteins important in biology such as marker proteins based on information such as data representation data of proteins that is obtained in two-dimensional electrophoresis.

In view of the above-described problems, it is another object of the present invention to provide a new analysis device that enables the search for, as target proteins, proteins important in biology such as marker proteins based on information such as representation data of proteins that is obtained by two-dimensional electrophoresis.

### Means for Solving the Problem

The protein search method according to the present invention is a protein search method for searching for, as a target protein, a protein directly or indirectly related to information based on protein representation profiling data that is acquired by proteome analysis, the protein search method including: determining, as the target protein, a protein related to information based on the significance of protein obtained by using supervised learning from information and protein representation in the profiling data, and evaluating performance of the target protein by means of evaluation data.

The first protein search device according to the present invention is a protein search device for searching for, as a target protein, a protein related to information based on protein representation profiling data acquired by proteome analysis, the first protein search device including: data storage means for storing information and protein representation data acquired by proteome analysis; target protein search means for using supervised learning from the protein representation data and the information to determine a target protein; target protein storage means for storing representations of the determined target protein; prediction model learning means according to target proteins for using the information and the representations of the determined target protein to learn a prediction model; prediction model storage means for storing the prediction model; evaluation data storage means for storing data for evaluating performance of the prediction model; and prediction model verification means for evaluating the prediction model by means of evaluation data.

The second protein search device according to the present invention is a protein search device for searching for, as a target protein, a protein related to information based on protein representation profiling data acquired by proteome analysis, the second protein search device including: data storage means for storing information and protein representation data acquired by proteome analysis; data dividing means for the dividing protein representation data into verification data and training data that is used in target protein search; training data storage means for storing the training data; verification data storage means for storing the verification data; target protein search means for using supervised learning from the training data and the information to determine a target protein; target protein storage means for storing representation of the determined target protein; prediction model learning means according to target protein for using the information and representation of the determined target protein to learn a prediction model; prediction model storage means for storing the prediction model; and prediction model verification means for evaluating the prediction model by means of the verification data.

According to the present invention, as one example, a search for target proteins such as marker proteins is enabled even when the representations of a plurality of proteins are relevant to information such as clinical information, and further, it is enabled to rationally determine the threshold values for determining whether proteins are target proteins.

### BRIEF DESCRIPTION OF THE DRAWINGS

FIG. 1 is a block diagram showing the configuration of a marker protein search device according to the first exemplary embodiment;

FIG. 2 is a flow chart showing an example of the processing procedure in the marker protein search device shown in FIG. 1;

FIG. 3 is a flow chart showing an example of the processing procedure for complementing missing values;

FIG. 4 is a flow chart showing an example of the processing procedure of stochastic gradient boosting;

FIG. 5 is a block diagram showing the configuration of a marker protein search device according to the second exemplary embodiment;

FIG. 6 is a flow chart showing an example of the processing procedure in the marker protein search device shown in FIG. 5;

FIG. 7 is a block diagram showing the configuration of a marker protein search device according to the third exemplary embodiment; and

FIG. 8 is a flow chart showing an example of the processing procedure in the marker protein search device shown in FIG. 7.

### EXPLANATION OF REFERENCE NUMERALS

1 Input device;
2 Data processing device;
3 Storage device;
4 Output device;
21 Missing value complement unit;
22 Data division unit;
23 Marker protein search unit;
24 Prediction model learning unit;
25 Verification unit;
31 Data storage unit;
32 Training data storage unit;
33 Verification data storage unit;
34 Parameter storage unit;
35 Marker protein storage unit;
36 Prediction model storage unit; and
37 Evaluation data storage unit.

### BEST MODE FOR CARRYING OUT THE INVENTION

Exemplary embodiments of the present invention are next explained. In the following description, an example is presented in which a comprehensive search is conducted for, as target proteins that are proteins directly or indirectly related to information, marker proteins that are directly or indirectly related to clinical information. Here, a comprehensive search of marker proteins is conducted by using ensemble learning on the representations of proteins that are obtained by proteome analysis.

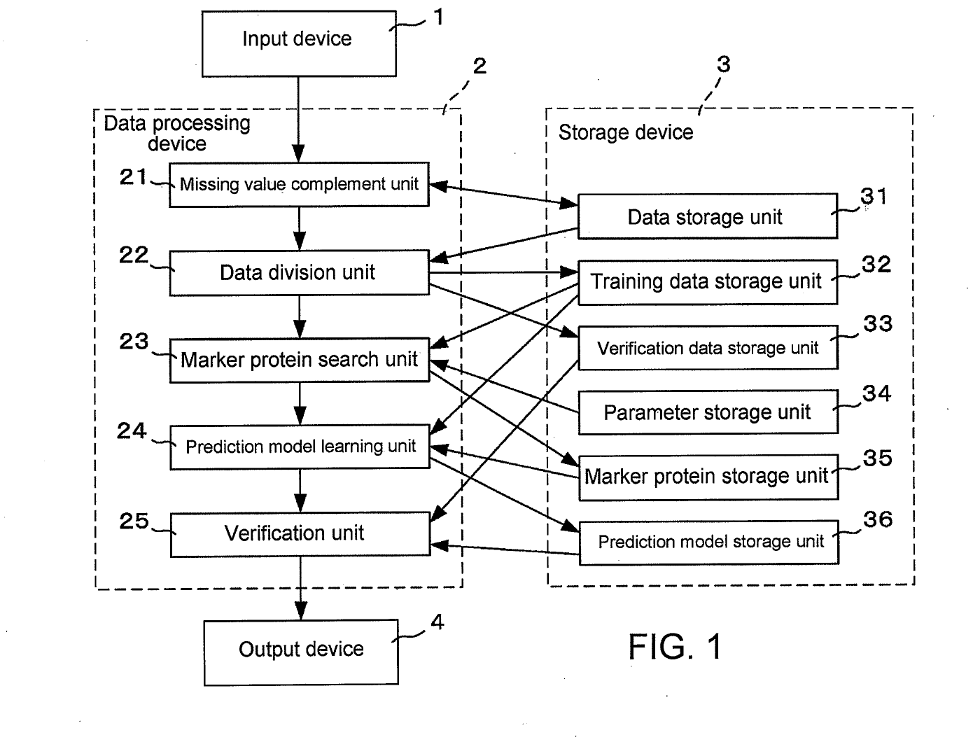

FIG. 1 shows the configuration of the marker protein search device according to the first exemplary embodiment. This marker protein search device conducts a search of proteins important in biology, i.e., marker proteins based on representation data of proteins obtained by, for example, two-dimensional electrophoresis.

The marker protein search device shown in the figure is generally made up from input device 1 such as a keyboard or pointing device, data processing device 2 that operates under the control of a program, storage device 3 for storing information, and output device 4 such as a display device or printer.

Data processing device 2 is provided with: missing value complement unit 21 for complementing the values of representation of proteins that have been lost; data division unit 22 for dividing all data between training data and verification data; marker protein search unit 23 for searching for marker proteins from training data; prediction model learning unit 24 for using representation of marker proteins and, for example, clinical information to learn a prediction model; and verification unit 25 for evaluating the classification performance of the prediction model based on the verification data. Here, missing value complement unit 21 is also referred to as a missing value complement means, data division unit 22 is also referred to as a data division means, marker protein search unit 23 is also referred to as a target protein search means, prediction model learning unit 24 is also referred to as a prediction model learning means, and verification unit 25 is also referred to as a prediction model verification means.

Storage device 3 is provided with: data storage unit 31 for storing protein representation and, for example, clinical information; training data storage unit 32 for storing training data that have been divided by data division unit 22; verification data storage unit 33 for storing verification data that have been divided by data division unit 22; parameter storage unit 34 for storing learning parameters used in the search for marker proteins by marker protein search unit 23; marker protein storage unit 35 for storing clinical information and marker protein information that has been searched; and prediction model storage unit 36 for storing a prediction model that has been learned by using clinical information and marker proteins in the training data. Here, data storage unit 31 is also referred to as a data storage means, training data storage unit 32 is also referred to as a training data storage means, verification data storage unit 33 is also referred to as a verification data storage means, marker protein storage unit 35 is also referred to as a target protein storage means, and prediction model storage unit 36 is also referred to as prediction model storage unit.

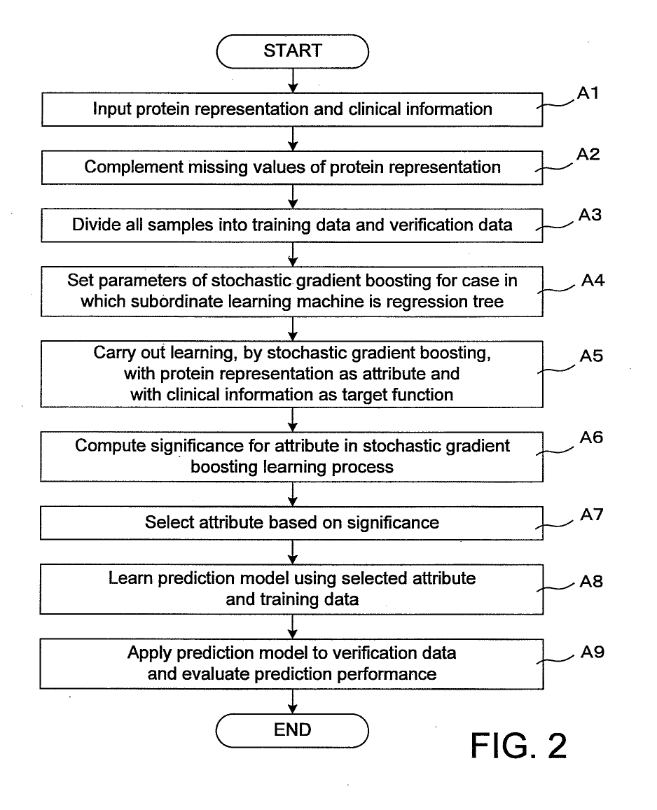

Explanation next regards the use of the marker protein search device shown in FIG. 1 to search for marker proteins. FIG. 2 is a flow chart showing an example of the processing procedure of the marker protein search.

Execution instructions are applied to the marker protein search device by means of input device 1, and the representation of proteins is entered as input to data storage unit 31 by way of input device 1 in Step A1. The representation received as input is stored in data storage unit 31. Here, the representation of proteins is obtained from, for example, protein representation profiling data acquired by proteome analysis. As the method of proteome analysis, a method can be used that employs two-dimensional electrophoresis and/or mass spectrometry. In addition, information that reflects the state of proteins such as chemical modification such as the phosphorylation of proteins or glycosylation can be used instead of the protein representation or in combination with the protein representation. Clinical information that corresponds to the representation of proteins is also stored in data storage unit 31 by way of input device 1 and data processing device 2. The representation of proteins is obtained when analyzing some samples by means of proteome analysis, but the clinical information that corresponds to the representation of proteins is information that relates to individuals that provided these samples. Clinical information refers collectively to information that relates to these clinical numerical values, information that relates to morbid states, information that relates to efficacy of medicines, and information that relates to survival time, i.e., how long an individual survived after collection of a sample.

The missing values of protein representation are next complemented by missing value complement unit 21 in Step A2, and protein representations for which missing values have been complemented are stored in data storage unit 31.

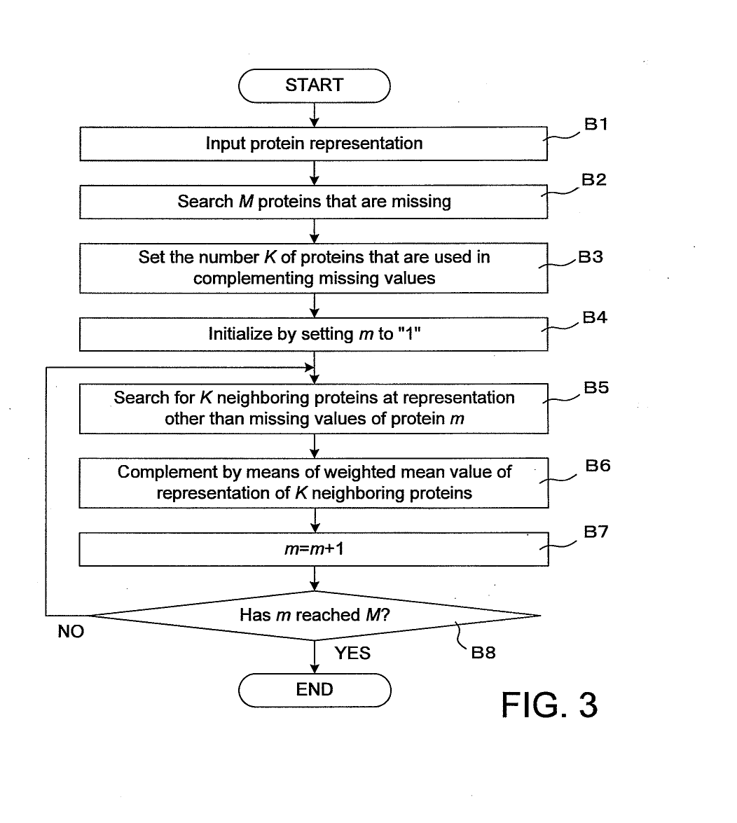

The actual method of complementing missing value by the k-nearest neighbors algorithm is next explained with reference to FIG. 3.

First, representations of proteins before complementing missing values are applied as input from data storage unit 31 to missing value complement unit 21 in Step B1. In Step B2, missing value complement unit 21 selects M proteins for which representations have been lost at a predetermined proportion and, in Step B3, sets the number K of proteins used in missing value complementing. Next, m is initialized as m=1 in Step B4, following which the Euclidean distance is calculated using the representations in samples that have not been lost and a number K of neighboring proteins are searched in Step B5, and in Step B6, the missing values are complemented by means of a weighted mean that accords with distance. If wᵢ is the weighting and xᵢ is the protein representation, the weighted mean is found by:

$$\frac{{\sum }_{i = 1}^{K} {w}_{i} {x}_{i}}{{\sum }_{i = 1}^{K} {w}_{i }} . \qquad ( 1 )$$

Next, in Step B7, “1” is added to m, and it is determined whether m has reached M or not in Step B8. The process hereupon returns to Step B5 if m<M but ends if m=M. As a result, the processes shown in Steps B4 and B5 are carried out for each of M proteins for which representations have been lost.

When missing values have been complemented, data division unit 22 receives the protein representation data of all samples after complementing missing values from data storage unit 31. In Step A3, a search is carried out for marker proteins, and the protein representation data of these marker proteins are divided between training data used in the learning of a prediction model and verification data for evaluating the performance of the prediction model that has been learned from the training data. The training data is stored in training data storage unit 32, and the verification data is stored in verification data storage unit 33.

In Step A4, marker protein search unit 23 next receives the protein representation of the training data and the corresponding clinical information from training data storage unit 32, receives parameters used in learning by stochastic gradient boosting from parameter storage unit 34, and sets the parameters of stochastic boosting when the subordinate learning machine is taken as a regression tree. After thus setting the parameters, marker protein search unit 23 calculates the significance that is an index of marker proteins for each protein by supervised learning. In the calculation of the significance, learning is realized in Step A5 by stochastic boosting in which the protein representation is taken as an attribute and clinical information is taken as the target function in supervised learning. The significance for attributes is computed in the process of learning by stochastic boosting, as shown in Step A6. Attributes are then selected based on the significance in Step A7. The representation of proteins that has been given a significance is then stored together with clinical information in marker protein storage unit 35.

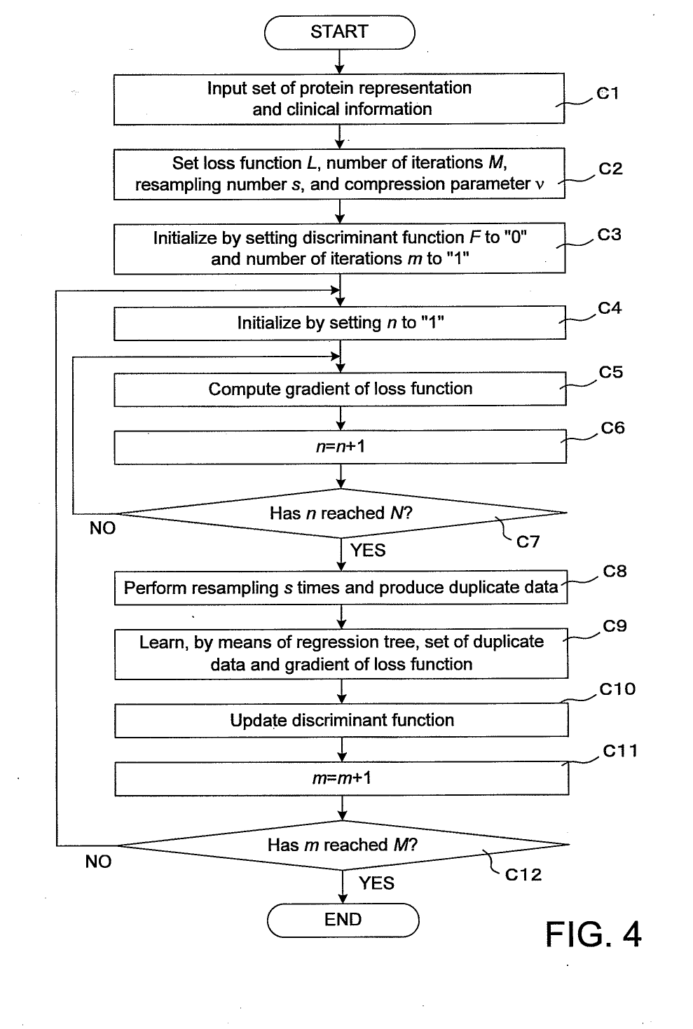

Referring next to FIG. 4, a concrete explanation is given regarding the method of computing the significance by means of stochastic gradient boosting.

Set D of the combination of protein representation and clinical information is first applied as input to marker protein search unit 23 from training data storage unit 32 in Step C1. N is the number of combinations, i.e., the number of samples for which representation has been obtained for proteins of interest.

D={(x₁, y₁), . . . , (x_{N}, y_{N})} (2)

where x is a protein representation and y is clinical information. Clinical information includes, for example, the disease, normalcy or malignancy, and the survival time. A compression parameter ν, a number s of resamplings, a number M of iterations of learning, and a loss function L appropriate to the type of clinical information are next set in Step C2. In a classification problem of distinguishing classes such as diseases and normalcy, the loss function L can use:

L=log(1+exp(−2yF(x))) (3)

where F(x) is a discriminant function. In addition, in a regression problem:

L=(y−F(X))² (4),

or

L=|y−F(x)| (5)

can be used.

In other words, when the clinical information comprises discrete values, a function such as a logarithmic function can be used as the loss function, and when the clinical information comprises continuous values, the square value of the difference between a true value and a predicted value or the absolute value of the difference between a true value and a predicted value can be used as the loss function. When the clinical information is the survival time, a Cox proportional hazards model may be used as the loss function.

The ranges of the magnitude of resampling number s and compression parameter ν are:

1<<s≦N (6),

0<ν≦1 (7).

Here, resampling number s and compression parameter ν are introduced to avoid overlearning of the original data.

Discriminant function F₀ and iteration number m are next initialized in Step C3 as shown below:

F₀=0 (8),

m=1 (9).

In Step C4, the number n of data items that are learned is initialized by the regression tree that is a subordinate learning machine as shown below:

n=1 (10).

In Step C5, the gradient of loss function L is computed by the following equation:

$${{r}_{n} = \frac{\partial }{\partial F ( {x}_{n} )} L ( {y}_{n} , F ( {x}_{n} ) ) \vert}_{F = {F}_{m - 1} ( {x}_{n} )} . \qquad ( 11 )$$

In Step C6 that follows Step C5, “1” is added to n, it is determined in Step C7 whether n has reached N or not, and if n<N, the process returns to Step C5, whereby the operation of computing the gradient of the loss function in Step C5 continues until n reaches N.

When n=N in Step C7, resampling of data is next performed s times and a duplicate data set generated in Step S8, and in Step C9, set R of the combination of the duplicate data and the gradient of the loss function is learned by regression tree Tₘ.

R={(rₙ_{ₗ}, xₙ_{ₗ}), . . . , (rₙ_{ₛ}, xₙ_{ₛ})} (12).

In Step C10, the discriminant function is updated as follows:

Fₘ(T₁(x), . . . , Tₘ(x))=Fₘ₋₁(T₁(x), . . . , Tₘ₋₁(x))+νTₘ(x) (13).

After Step C10, “1” is added to M in Step C11, it is determined in Step C12 whether m has reached M, and if m<M, the process returns to Step C4, whereby the operations from Step C5 to Step C10 are continued until m becomes M.

The significance Vₚ of protein p is computed by the following equation in the learning process of the regression tree of the above-described stochastic gradient boosting:

$${V}_{F}^{2} = \frac{1}{M} {\sum }_{m = 1}^{M} {V}_{F}^{2} ( {T}_{m} ) . \qquad ( 14 )$$

Here, Vₚ(Tₘ) is the significance when learning the m^{th} regression tree and is defined by the equation below:

$${V}_{F}^{2} ( {T}_{m} ) = {\sum }_{t = 1}^{{J}_{m} - 1} {δ}_{t}^{2} I [ t = p ] . \qquad ( 15 )$$

Here, Jₘ is the number of non-terminal nodes of the m^{th} regression tree, I[t=p] is an index variable that becomes “1” when the protein that branches at node t is p, and δₜ² is the amount of improvement of the mean square error when dividing at node t. In other words, proteins that lack branching variables in all regression trees of the learning process have a significance of “0,” meaning that these proteins make absolutely no contribution to clinical information variables and have no relation to clinical information.

In the present exemplary embodiment, the method of computing the significance of proteins of interest is not limited to only stochastic gradient boosting described here, but can employ other methods including ensemble learning such as boosting and bagging. However, when there are few items of data, the use of stochastic gradient boosting is preferable.

As described in the foregoing explanation, if the significance that is the index of each protein as marker proteins is computed from training data in marker protein search unit 23, prediction model learning unit 24 in Step A8 next accepts clinical information and protein representations of training data from training data storage unit 32 and accepts the representation of proteins from marker protein storage unit 35, and learns a prediction model by supervised learning such as a support vector machine or unsupervised learning such as clustering. The prediction model after learning is stored in prediction model storage unit 36.

In Step A9, verification unit 25 accepts the prediction model from prediction model storage unit 36 and accepts the verification data from verification data storage unit 33 and carries out prediction for the clinical information of the verification data. The prediction results are supplied from output device 4.

In the marker protein search device of the first exemplary embodiment described hereinabove, complementing of the representation of proteins that are lost enables searching for proteins that relate to clinical information from among a greater number of proteins and therefore has the effect of increasing the possibility of discovering marker proteins that could not previously be discovered.

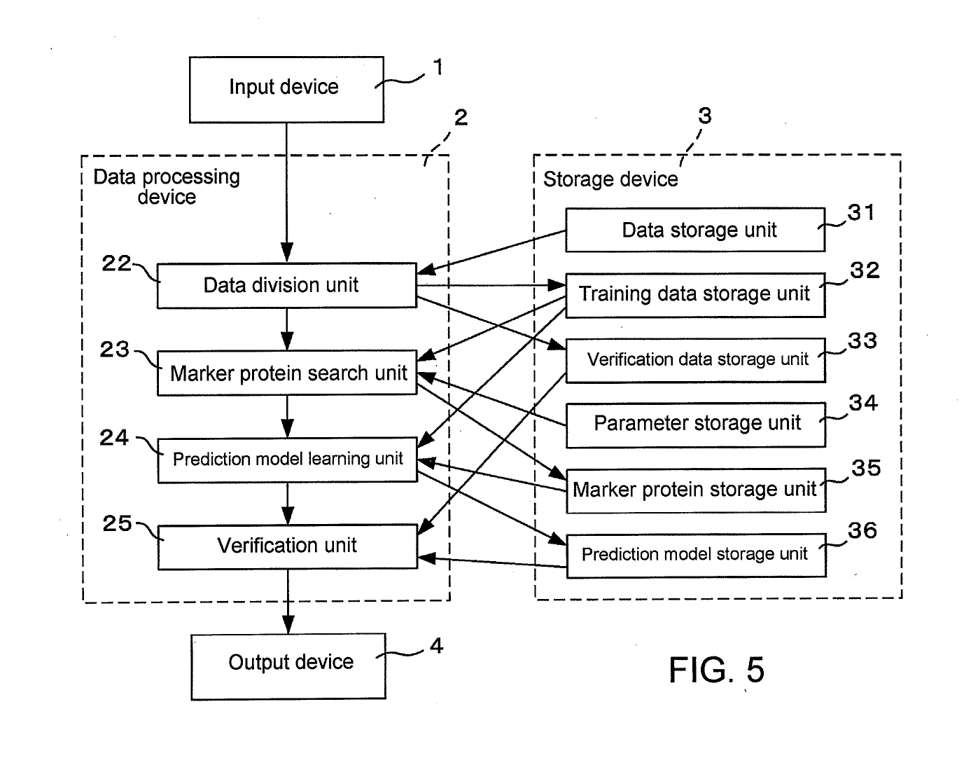

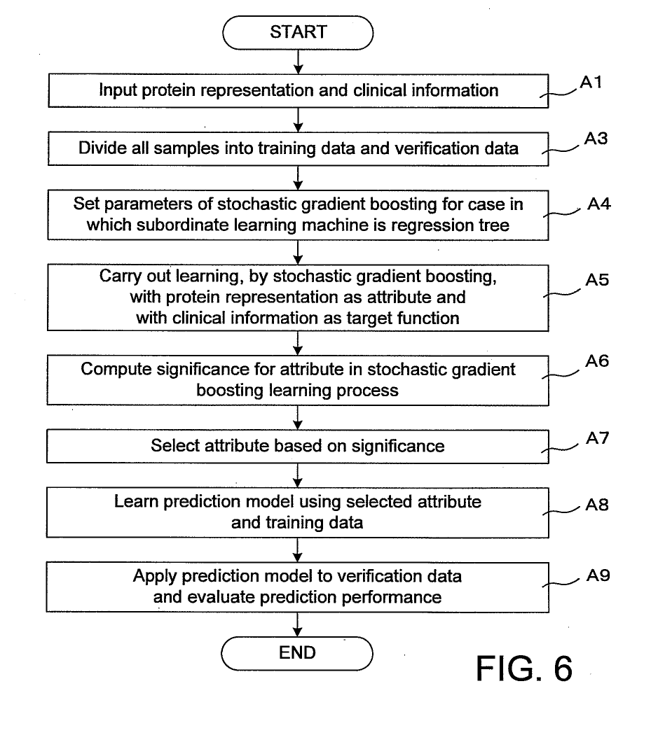

FIG. 5 shows the configuration of the marker protein search device according to the second exemplary embodiment. The marker protein search device shown in FIG. 5 has been adapted for cases in which all representation of proteins in a sample can be measured or cases in which only those proteins for which representation can be measured are taken as the objects of analysis. Compared to the marker protein search device of the first exemplary embodiment shown in FIG. 1, the device shown in FIG. 5 differs in that the missing value complement unit is not provided. FIG. 6 is a flow chart showing an example of the marker protein search process in the device shown in FIG. 5, and compared with the process in the first exemplary embodiment shown in FIG. 2, differs only in that the missing value complementing process is not provided. The device shown in FIG. 5 does not perform complementing of missing values in representation, but otherwise executes a marker protein search process that is identical to that of the device shown in FIG. 1.

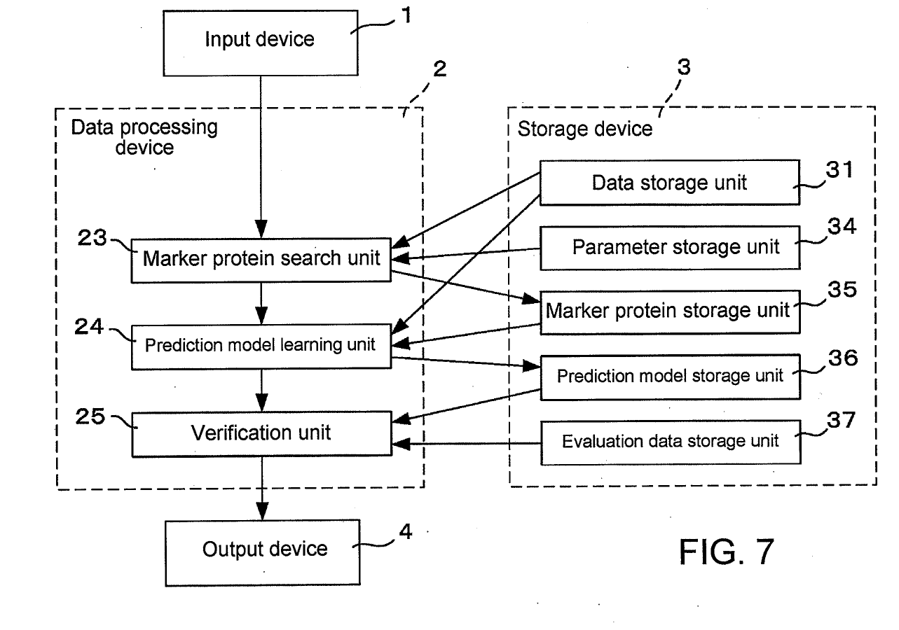

FIG. 7 shows the configuration of the marker protein search device according to the third exemplary embodiment. The marker protein search device shown in FIG. 7 uses all data to search for marker proteins without dividing representation profile data between training data and verification data and evaluates the prediction performance realized by marker proteins by means of evaluation data that has been separately prepared. Compared to the device shown in FIG. 5, the device shown in FIG. 7 lacks the data division unit, training data storage unit, and verification data storage unit, and instead, is provided with evaluation data storage unit 37 in storage device 3. Here, marker protein search unit 23, which is also referred to as a target protein search means, uses supervised learning to determine marker proteins from protein representation data and clinical information that are stored in data storage unit 31. Evaluation data storage unit 37 is also referred to as a evaluation data storage means and stores evaluation data that is used for evaluating the performance of a prediction model.

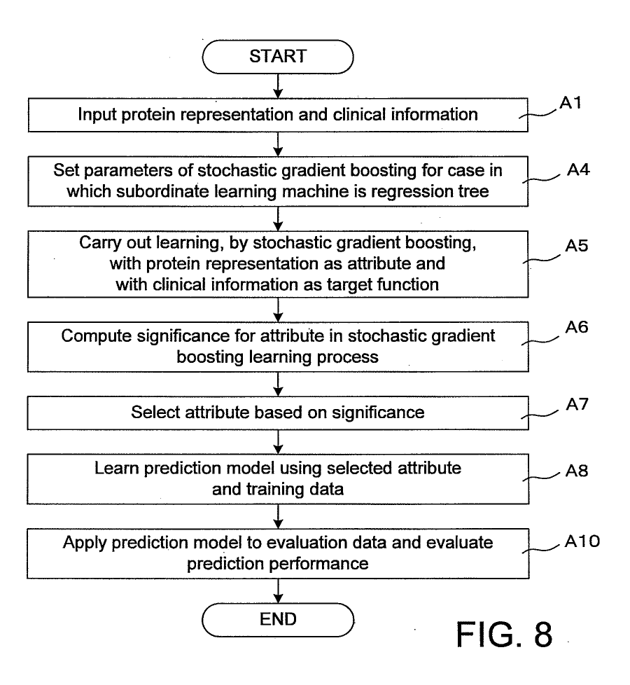

FIG. 8 is a flow chart showing an example of the marker protein search process in the device shown in FIG. 7. Execution instructions are given by input device 1, and in Step A1, representation of proteins and corresponding clinical information is applied as input by way of input device 1 to data storage unit 31 and stored in data storage unit 31. Next, in Step A4, marker protein search unit 23 receives from data storage unit 31 the protein representation of training data and the corresponding clinical information, receives parameters used in learning of stochastic gradient boosting from parameter storage unit 34, and sets the parameters of stochastic boosting when it is assumed that the subordinate learning machine is a regression tree. After thus setting the parameters, marker protein search unit 23 computes the significance that is the index of each marker as marker proteins. In the computation of significance in Step A5, learning is carried out by stochastic boosting with protein representation as attribute and clinical information as the object function. In the stochastic boosting learning process, significance is computed for attribute as shown in Step A6.

Marker protein search unit 23 next selects attribute based on the significance in Step A7. The representation of protein to which significance has been given is then stored in marker protein storage unit 35. In Step A8, prediction model learning unit 24 then receives protein representation and clinical information from data storage unit 31, receives the representation of proteins from marker protein storage unit 35, and performs supervised learning such as a support vector machine or unsupervised learning such as clustering to learn a prediction model. The prediction model after learning is stored in prediction model storage unit 36. In Step A10, verification unit 25 next receives the prediction model from prediction model storage unit 36 and receives evaluation data from evaluation data storage unit 37 to make prediction of the evaluation data for clinical information. The results of prediction are supplied from output device 4.

In the third exemplary embodiment, as in the first exemplary embodiment, a configuration can be adopted that is provided with missing value complement unit 21 to complement missing values.

The marker protein search method of each of the above-described exemplary embodiments can be realized by causing a computer such as a personal computer or a work station to read a computer program for realizing the marker protein search method and then execute the program. The program for carrying out the marker protein search is read to the computer by a recording medium such as a magnetic tape or CD-ROM or by way of a network. Such a computer is typically made up from: a CPU (Central Processing Unit), an external storage device for storing programs and data, a main memory, an input device such as a keyboard or mouse, an output device or a display device such as a CRT (Cathode Ray Tube) or liquid crystal display device (LCD), a reading device for reading a recording medium such as a magnetic tape or CD-ROM, and a communication interface for connecting to a network. A hard disk drive or the like is used as the external storage device.

In this computer, the recording medium that stores a program for executing the marker protein search is mounted on the reading device, the program is read from the recording medium and stored in the external storage device, and the program that is stored in the external storage device is executed by the CPU, or alternatively, the program is downloaded into the external storage device by way of a network and the program that is stored in the external storage device is executed by the CPU, whereby the above-described marker protein search method is executed.

According to each of the above-described exemplary embodiments, even when the representation of a plurality of proteins relate to clinical information, search of marker proteins as target proteins is possible and a threshold value for determining whether a protein is a marker protein or not can be logically determined. In addition, the exemplary embodiments enable the efficient determination of marker proteins that are to be identified by amino acid sequence determination by mass spectrometry, and further, enable a major reduction of the time and effort required for protein identification. Complementing missing values raises the exhaustivity of proteins that can be compared by groups and enables the acquisition of more biological information.

In the protein search method of another exemplary embodiment, a stage may be further provided for dividing profiling data into verification data and training data used in the target protein search, whereby, in the determination stage, a protein that is related to clinical information may be determined as a target protein based on the significance of protein that is obtained using supervised learning from the clinical information and the protein representation in the training data, and in the evaluation stage, verification data may be used as evaluation data. In addition, in yet another exemplary embodiment, another stage may be included for using the representation of other proteins to complement the missing value of protein representation.

Yet another object of the present invention is to provide a protein search method that enables search for relevance between the representation of a plurality of proteins and clinical information by stochastic gradient boosting without setting threshold values, and moreover, to complement missing values of protein representation to raise the exhaustivity of proteins that can be compared by groups.

Yet another object of the present invention is to provide a protein search device that enables search for relevance between the representation of a plurality of proteins and clinical information by means of stochastic gradient boosting without setting threshold values, and moreover, that can carry out missing value complementing of protein representation and raise exhaustivity of proteins that can be compared in groups.

This patent application claims priority based on Japanese Patent Application No. 2006-194065 filed on Jul. 14, 2006, the disclosure of which is incorporated herein in its entirety by reference.

### Examples

The result of one example of working the present invention is next described.

Proteome analysis was carried out by means of fluorescent two-dimensional difference gel electrophoresis upon samples of cancerous portions of liver cancer and samples of noncancerous portions in the liver. Using the results of this proteome analysis, the procedure described in the first exemplary embodiment was used to search for proteins. The number of proteins that could be analyzed as a result when complementing of missing values was not carried out was 101, but carrying out 20% missing value complementing enabled analysis of 658 proteins, or more than six times as many proteins, for a dramatic improvement in exhaustivity. In addition, when stochastic gradient boosting was used in searching for marker proteins that are effective in distinguishing cancerous portions and noncancerous portions, 25 marker proteins were found when complementing of missing values was not carried out, but 20% missing value complementing enabled automatic detection of 42 marker proteins.

Although the present invention has been described hereinabove with reference to exemplary embodiments and examples, the present invention is not limited to the above-described embodiments and working example. The configuration and details of the present invention are open to various modifications within the scope of the present invention that would be clear to one expert in the art.

1. A protein search method for searching for, as a target protein, a protein directly or indirectly related to information based on protein representation profiling data that is acquired by proteome analysis, said protein search method comprising:
determining, as the target protein, a protein related to said information based on significance of protein obtained by using supervised learning from said information and protein representation in said profiling data; and
evaluating performance of said target protein by means of evaluation data.

2. The method according to claim 1, further comprising dividing said profiling data into verification data and training data used in target protein search; wherein:
when determining a protein that is relevant to said information as said target protein, a protein that is relevant to said information is determined as said target protein based on significance of protein that is obtained using supervised learning from said information and protein representation in said training data; and
when evaluating performance of said target protein, said verification data is used as said evaluation data.

3. The method according to claim 1, further comprising complementing a missing value of said protein representation by using representation of other protein.

4. The method according to claim 3, wherein the missing value of protein representation is complemented by a k-nearest neighbor algorithm.

5. The method according to claim 1, wherein said significance is computed by using improvement of a target variable and a branching variable generated in a process of learning by a decision tree or regression tree of a subordinate learning machine of ensemble learning.

6. The method according to claim 1, wherein said significance is computed using one of boosting, bagging, gradient boosting, and stochastic gradient boosting.

7. The method according to claim 1, wherein said information is clinical information, and said target protein is a marker protein.

8. The method according to claim 7, wherein, when said clinical information comprises discrete values, a logarithmic function is used as a loss function in said supervised learning.

9. The method according to claim 7, wherein, when said clinical information comprises continuous values, a square value of difference between a true value and a prediction value or an absolute value of the difference between a true value and a prediction value is used as a loss function.

10. The method according to claim 7, wherein, when said clinical information is survival time, a Cox proportional hazards model is used in a loss function.

11. The method according to claim 1, wherein said proteome analysis is carried out by mass spectrometry and/or two-dimensional electrophoresis.

12. A protein search device for searching for, as a target protein, a protein relevant to information based on protein representation profiling data acquired by proteome analysis, said protein search device comprising:
a data storage which stores information and protein representation data acquired by proteome analysis;
a target protein search units which uses supervised learning from said protein representation data and said information to determine a target protein;
a target protein storage which stores representation of said determined target protein;
a prediction model learning unit according to target protein which uses said information and said representation of said determined target protein to learn a prediction model;
a prediction model storage which stores said prediction model;
an evaluation data storage which stores data for evaluating performance of said prediction model; and
a prediction model verification unit which evaluates said prediction model by means of said evaluation data.

13. A protein search device for searching for, as a target protein, a protein relevant to information based on protein representation profiling data acquired by proteome analysis, said protein search device comprising:
a data storage which stores information and protein representation data acquired by proteome analysis;
a data dividing unit which divides said protein representation data into verification data and training data used in target protein search;
a training data storage which stores said training data;
a verification data storage which stores said verification data;
a target protein search unit which uses supervised learning from said training data and said information to determine a target protein;
a target protein storage which stores representation of said determined target protein;
a prediction model learning unit according to target protein which uses said information and representation of said determined target protein to learn a prediction model;
a prediction model storage which stores said prediction model; and
a prediction model verification unit which evaluates said prediction model by means of said verification data.

14. The device according to claim 12, further comprising a missing value complement unit which complements a missing value of representation of said target protein by using representation of other protein.

15. The device according to claim 12, wherein said information is clinical information and said target protein is a marker protein.

16. A recording medium that is readable by a computer for storing a program that causes a computer to execute processes for searching for, as a target protein, a protein that is directly or indirectly relevant to information based on protein representation profiling data acquired by means of proteome analysis; said program causing said computer to execute: a process of determining, as a target protein, a protein that is relevant to said information based on significance of protein obtained by using supervised learning from said information and protein representation in said profiling data; and a process for evaluating performance of said target proteins by means of evaluation data.

17. A recording medium that is readable by a computer for storing a program that causes a computer to execute processes for searching for, as a target protein, a protein that is directly or indirectly relevant to clinical information based on protein representation profiling data acquired by means of proteome analysis; said program causing said computer to execute: a process of dividing said profiling data into verification data and training data used in target protein search; a process of determining, as a target protein, a protein that is relevant to said information based on significance of protein obtained by using supervised learning from said information and protein representation in said training data; and a process for evaluating performance of said target proteins by means of said verification data.

18. The recording medium according to claim 16, wherein said program causes said computer to further execute a process of complementing a missing value of said protein representation by using representation of other protein.

19. The recording medium according to claim 16, wherein said information is clinical information, and said target protein is a marker protein.
